(19) United States
(12) Patent Application Publication
(10) Pub. No.: US 2005/0277024 A1
(43) Pub. Date: Dec. 15, 2005

(54) Nickel precoat for electrode plates

(75) Inventors: Jon K. West, Gainesville, FL (US); Thomas E. Audit, Alachua, FL (US); Thomas J. McCall, Ft. White, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/867,205

(22) Filed: Jun. 15, 2004

(51) Int. Cl. H01M 4/80; H01M 4/66; H01M 4/58; H01M 4/52

(52) U.S. Cl. 429/235; 429/218.2; 429/245; 429/223

(57) ABSTRACT

The disclosure relates to increasing the performance of batteries by reducing the internal resistance of the electrodes and improving the adhesion of electrolytic materials to metal substrates used in the manufacture of electrodes for energy storage cells. In one embodiment, the present invention may be illustrated as a system and method for increasing battery performance by precoating the electrode plates with nickel, to improve the adherence of the metal hydrides, or other electrolytic materials, to the metallic substrate. For example, by precoating a nickel plated steel substrate with powdered nickel at or near the glass transition temperature of 1100° C., the adhesion of nickel metal hydride powder is improved, providing an electrode with reduced internal resistance, when compared to electrodes in which the metal substrate is not precoated with nickel.

### FIELD OF THE INVENTION

The disclosure relates to improving the performance of batteries by reducing the internal resistance of the electrodes. In one embodiment, the present invention may be illustrated as a system and method for increasing battery performance by precoating the electrode plates with Nickel, to improve the adherence of the metal hydrides, or other electrolytic materials, to a metallic substrate.

### BACKGROUND OF THE RELATED ARTS

There are a number of processes to form electrodes for use in rechargeable cells. One well known method involves sintering. Sintered positive nickel hydroxide electrodes are typically formed by sintering nickel powder at elevated temperatures to form a porous three dimensional plaque and then impregnating this porous structure with nickel salts which are subsequently converted to nickel hydroxide. The three-dimensional substrate refers to a porous substrate having at least a portion of its interior surface area in contact with electrochemically active material.

U.S. Pat. No. 2,724,733, for example, describes a sintered electrode structure for a nickel cadmium cell having nickel hydroxide as the active material for the sintered positive electrode. U.S. Pat. No. 3,826,684 also describes a nickel cadmium cell having a sintered positive nickel electrode containing additives to enhance charge acceptance. However, the manufacturing process for the sintered electrode is capital intensive. The porous three-dimensional sinter plaque structure is impregnated by immersing the plaque in a nickel salt bath and converting the nickel salt to nickel hydroxide by the reaction of the salt with caustic. To obtain an electrode containing a sufficient amount of active material, this immersion step must be repeated several times. The sintered nickel electrode therefore requires a costly, complicated and time consuming process for its fabrication.

Another process to form electrodes involves forming a paste from nickel hydroxide and other additives and depositing the paste into an appropriate three-dimensional substrate. Such three-dimensional substrates are typically formed by nickel plating polyurethane foams, non woven felts and carbon fiber mats, and are referred to in the art as sponge metal, foamed porous metal, porous metal matrix, and felt. U.S. Pat. Nos. 4,251,603 and 4,582,098 are representative of processes which use a sponge-like three-dimensional porous metal matrix to form the electrode. Specifically, U.S. Pat. No. 4,251,603 describes a battery electrode having a carrier made of a sponge-like porous metal matrix having a multiplicity of spaces throughout. An active material paste fills the matrix followed by drying, calendering and cutting to the desired size. U.S. Pat. No. 4,582,098 describes a method of spraying a pasty mixture into a porous three-dimensional metal body from both sides so as to fill the pores with the mixture. As compared to sintered electrodes, foam electrodes provide greater capacity, e.g., 1250 mAH as compared to 1100 mAH in a typical AA cell. The higher porosity of the foam material is believed to contribute to the greater capacity of the foam electrode. However, the materials and manufacturing costs for foam positive electrodes are also high.

Both of these processes for manufacturing an electrode require that a porous three-dimensional substrate be filled with active material, a process more costly and complex than a coating process. Efforts have been undertaken to provide for a rechargeable positive electrode with a two-dimensional current collector substrate supporting a layer of active material on each major surface of the substrate. A two-dimensional current collector or electrically conductive substrate refers to a substrate such as a foil sheet where the substrate thickness is not coextensive with the electrode thickness and the electrochemically active material contacts essentially the external surface area of the substrate. Volume changes that occur in the positive electrode have hampered efforts to provide satisfactory adhesion between the two-dimensional conductive substrate and the active material when the material is coated onto the substrate. As a result, the active material separates from the substrate, reducing capacity and increasing resistance. Various non-coating methods for forming a positive electrode with a two-dimensional current collector substrate have been proposed. For example, U.S. Pat. No. 3,898,099 describes an electrode sheet formed of active material and polytetrafluoroethylene (PTFE) fibers as a binder wherein the sheet is subsequently pressed onto a metal screen or foil current collector. This process is complex in that the active material electrode sheet is formed by repeated working of the paste by rolling and folding in order to form a cohesive sheet. A current collector substrate is then sandwiched between sheets to form the electrode assembly followed by additional pressure to the assembly to form the finished electrode. Another proposed solution to the adhesion problem for a positive electrode using a two-dimensional substrate is to corrugate a two-dimensional substrate and then apply a thin sintered metal layer on the surfaces of the corrugated substrate prior to coating with an active material. The required additional working of the substrate to provide a corrugated profile adds additional manufacturing costs to the electrode.

Further, when using a metal hydride (NiMH) powder to form a negative electrode, a problem exists when it is extruded onto a very smooth nickel plated steel substrate. Moreover, nickel presintering has been tried as a means for increasing the adhesion between the NiMH powder and metal substrate, but conventional NiMH plates do not have an edge prepared for the subsequent welding operation to attach the current collectors onto a coiled electrode.

It would therefore be desirable to provide a positive and negative electrode plate with lower internal resistance, to improve cell performance, better adhesion of electrolytic powders to the metal substrates, and a well-prepared edge to facilitate the connection of a coiled electrode to a current collector.

### SUMMARY OF THE INVENTION

The present disclosure relates to a system and method for providing improved electrodes for use in energy storage devices. In a preferred embodiment, the method may include sintering a layer of powdered metal onto a metal substrate upon which an electrolytically active material may be disposed to create an electrode. One of the preferred substrate materials is nickel plated steel. One of the preferred powdered metals is nickel. The metal may preferably be sintered on to the metal substrate at about the glass transition temperature of the powdered metal.

In a preferred embodiment, an electrode may have a layer of sintered metal on a metal substrate over which an electrolytically active or non-active material may be placed. Such electrolytically active and non-active materials may include, for example, Ni(OH)₂, which may be formed on the layer of sintered, powdered metal, sintered Nickel powder, Nickel foam or NiMH, which may be disposed by means such as extrusion, spraying, painting, etc. The present specification provides an example of the use of extrusion as a means for applying a layer of material onto a metal substrate. Those skilled in the art will recognize that a precoating method and system in accordance with the present invention may be applied to electrode manufacturing methods that do not employ extrusion. Further, such an electrode may also include wiped edges to provide a clean surface upon which to connect a current collector the electrode.

### BRIEF DESCRIPTION OF THE DRAWING FIGURES

FIG. 1 is an illustration of an exemplary process for creating electrode plates having a sintered nickel coating.

FIG. 2 is a cross-sectional illustration of an exemplary device for depositing a coating layer onto a metallic substrate and providing a wiped edge.

FIG. 3 is a micrograph illustrating an example of a non-presintered nickel plated perforated 3 mil steel substrate.

FIG. 4 is a micrograph illustrating an example of a presintered nickel plated perforated 3 mil steel substrate.

### DETAILED DESCRIPTION OF THE INVENTION

The present invention, in a preferred embodiment, relates to an electrical energy storage device and, more specifically, to rechargeable storage cells. By way of example and illustration, the present specification describes D-Cell batteries. It is noted, however, that each of the principles and discoveries mentioned herein apply with equal weight to cells having a coiled energy storage device, such as AA, AAA, C, for example, and other cells, such as those which do not use cylindrically wound coils like prismatic batteries, oval cells, etc. Exemplary energy storage devices for use in accordance with the presently disclosed system and method are described in U.S. Pat. No. 6,265,098, U.S. Pat. No. 5,667,907, U.S. Pat. No. 5,439,488, and U.S. Pat. No. 5,370,711, each of which is hereby incorporated by reference in its entirety.

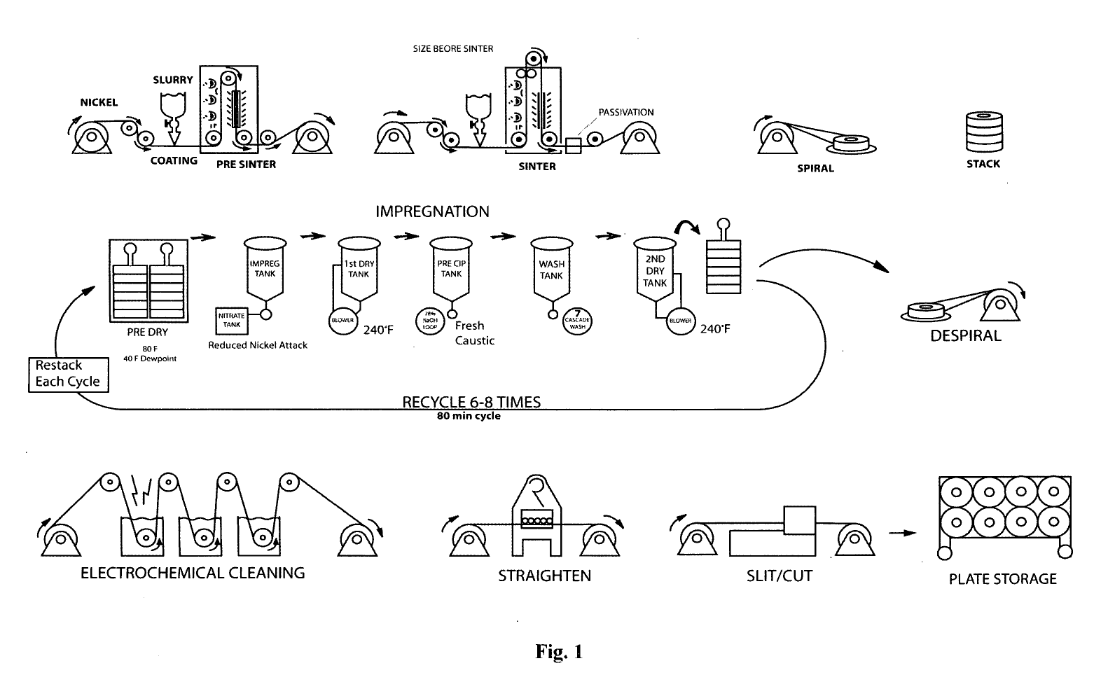

In the manufacture of rechargeable energy storage cells, metal substrates may be coated with powdered electrolytic material to form an electrode. FIG. 1 illustrates an example of a process by which slurry may be pre-sintered and then sintered onto a metallic substrate. An impregnation process may then be carried out prior to cleaning, straightening, and cutting the substrate into individual electrodes for use in energy storage cells. When making a D-Cell type battery, for example, a pair of electrodes are coiled with a separator between them, collectors are welded to each edge of the coil, and the coil is inserted into a casing which is then filled with an electrolyte solution. One problem that arises is that when making the electrodes, the powdered material does not adhere well to the metal substrate. In a negative electrode, the powdered material may be a nickel metal hydride (NiMH) that is extruded onto a nickel-plated steel substrate. During the manufacturing process, the NiMH material may flake off the metal substrate, resulting in a battery with reduced electrode capacity and lower output. Further, the poor adhesion between the NiMH material and the nickel steel substrate is a source of internal resistance that also may reduce battery performance.

It has been found that by sintering a layer of powdered nickel, preferably a thin layer, onto the nickel steel substrate, the adhesion of the NiMH active material is improved, providing a negative electrode with lower internal resistance than one produced without a layer of sintered nickel on the steel substrate. The layer of material deposited on the substrate may be electrolytically active or non-active. In general, the layer may comprise transition metals that provide a precoat on a nickel plated steel or pure nickel substrate. Other metals may be used for the substrate, depending on the type of electrode being produced and whether the electrode will be used on a wound, prismatic, or other type of cell. Moreover, a second layer of non-electrolytic material may be sintered onto or otherwise deposited over the sintered precoat to further improve the adhesion of electrolytic material to the substrate and improve the overall reliability and performance of the electrode. Suitable materials for either or both layers may include, without limitation, transition metals, powders and foams thereof, and preferably be selected from the group comprising nickel, zinc, zinc oxide, nickel foam, porous nickel, porous cadmium, and porous silver. Additional suitable materials may include pure nickel, copper, aluminum, and alloys comprising transition metals.

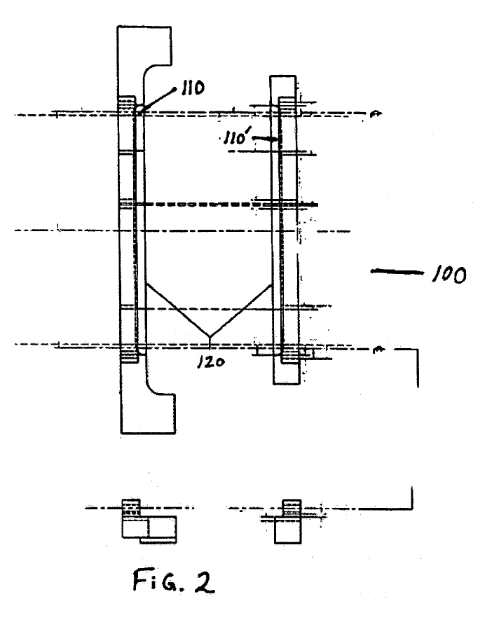

Illustrative of the present method for improving the performance of a negative electrode, a presintering composition comprising at least powdered nickel and binders is applied to the Ni plated steel substrate. Once the Ni powder is coated onto the steel substrate, it then goes through a doctor blade for wiping clean edges to facilitate the attachment of current collectors to the electrode. An exemplary device 100 for coating a substrate is shown in FIG. 2. Slots 110 and 110′ are provided in machined surfaces 120 for controlling the substrate. Wiper blades may be provided, as shown, to provide wiped edges on the substrate. Alternatively, there may be three portions of the substrate wipe—both edges and a center strip. This provides for four pieces of substrate when cut, thus wiping the center strip creates an edge if the substrate is slit down the middle lengthwise. Wiping the nickel powder will assist in non-adhesion of the metal hydride during the application of metal hydride stage, as well. The nickel powder is fused onto the substrate at the sintering furnace at about 1100° C., which is at or near the glass transition temperature for nickel, for approximately 60 seconds.

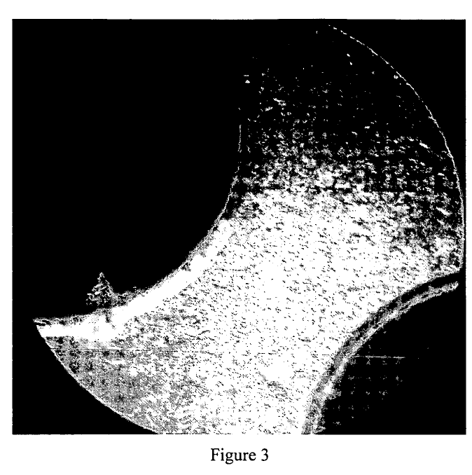

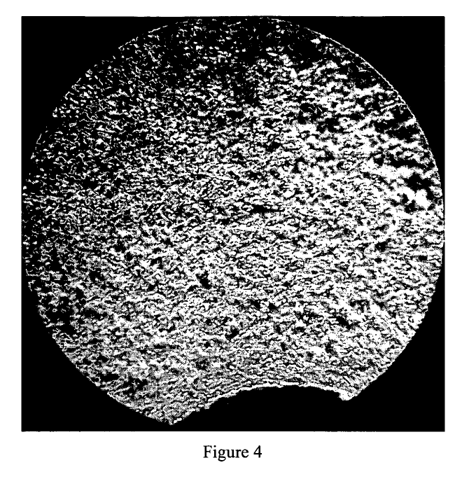

A metal hydride paste is then disposed onto the nickel sintered substrate through an extruding machine. During application and processing of the metal hydride, the edges are wiped cleaned by doctor blades that may be incorporated into the extruder, although they may be provided elsewhere in the process. The nickel powder is fused to the substrate before the metal hydride powder is extruded onto the substrate, in order to prevent flaking of the active material by providing a surface upon which the metal hydride paste can adhere to, as shown in FIG. 4. Prior art methods, in comparison, provide a surface as shown illustratively in FIG. 3 which does not provide as good adhesion as the surface created by the presently disclosed method. Current practices extrude directly on to a smooth nickel plated substrate.

After metal hydride is extruded onto the sintered substrate, it is dried and wound in preparation for sizing. Once it is sized it is ready for slitting and winding.

In one illustrative embodiment, a doctor blade used in an extruder in accordance with the present method may comprise pressure pad slots divided into two halves and a wiper slot also divided into two halves, as shown in FIG. 2. The die is disposed within the extruder. The doctor blade or blades can be adjusted according to the thickness of the substrate and/or the thickness of the coating. A typical metal substrate used for rechargeable cells is about 2-4 mils. Further, the extruder may include one or more wipers made of metal, rubber, combinations thereof, or other materials that can be adjusted, depending on the type of substrate being coated. The substrate that is fed through the doctor blade is typically made of perforated nickel plated steel or any other conductive material suitable as a substrate in the manufacture of electrodes for energy storage cells.

An energy storage device in accordance with the present invention may be used for storing and supplying energy in a variety of different environments and for a variety of different purposes. For example, an energy storage device in accordance with the present invention may be used for storing and supplying energy in transportation vehicles, including for example ground transportation vehicles, air transportation vehicles, water surface transportation vehicles, underwater transportation vehicles, and other transportation vehicles. An energy storage device in accordance with the present invention may be used for storing and supplying energy in communication and entertainment devices, including for example telephones, radios, and televisions, and other communication and entertainment devices. An energy storage device in accordance with the present invention may be used for storing and supplying energy in home appliances as an alternative to AC current sources or in conjunction therewith. When used with an appropriate power inverter, energy storage devices of the present invention may also provide a substitute for AC current sources when such sources are unavailable or inconvenient. The examples described in this paragraph are merely representative, not definitive.

1. An electrode configured for use in an energy storage device, the electrode comprising:
a metal substrate,
at least a first layer comprising a sintered powdered metal, and
at least a second layer comprising an electrolytic material.

2. The electrode of claim 1 wherein the electrolytic material comprises at least one of Ni(OH)₂ and NiMH.

3. The electrode of claim 1 wherein the metal substrate comprises nickel plated steel.

4. The electrode of claim 1 wherein the sintered powdered metal comprises nickel.

5. The electrode of claim 1 wherein at least one of the first layer and the second layer are absent from at least a portion of the substrate.

6. An energy storage device comprising:
an electrode, the electrode comprising:
a metal substrate,
at least a first layer comprising a sintered powdered metal, and
at least a second layer comprising an electrolytic material.

7. The device of claim 6 wherein the electrolytic material comprises at least one of Ni(OH)₂ and NiMH.

8. The device of claim 6 wherein the metal substrate comprises nickel plated steel.

9. The device of claim 6 wherein the sintered powdered metal comprises nickel.

10. The device of claim 6 wherein at least one of the first layer and the second layer are absent from at least a portion of the substrate.

11. A method of making an electrode for an energy storage device, the method comprising:
providing a metal substrate,
sintering a powdered metal on the substrate to provide at least a first layer, and
disposing an electrolytic material on the first layer.

12. The method of claim 11 comprising preventing the powdered metal from being sintered on at least a portion of the substrate.

13. The method of claim 11 comprising removing the sintered powdered metal from at least a portion of the substrate.

14. The method of claim 11 comprising preventing the electrolytic material from being disposed on at least a portion of the substrate.

15. The method of claim 11 comprising removing the electrolytic material from at least a portion of the substrate.

16. The method of claim 11 wherein the powdered metal has a glass transition temperature and wherein the step of sintering the powdered metal comprises sintering at a temperature corresponding to the glass transition temperature.

17. A method of enhancing adherence of electrolytic material to a metal substrate comprising:
sintering a powdered metal on the substrate to provide at least a first layer, and
disposing an electrolytic material on the first layer.

18. A method, comprising:
sintering a powdered metal on a metal substrate,
disposing an electrolytically active material on the metal substrate, and
using the metal substrate as an electrode in an energy storage device.

19. A method, comprising:
sintering powdered nickel on a metal substrate, and
disposing nickel metal hydride on the metal substrate.

20. The method of claim 19, comprising using the metal substrate as an electrode in an energy storage device.

21. The method of claim 19 wherein the metal substrate comprises nickel plated steel.

22. A method, comprising:
sintering a powdered metal on a metal substrate, and
forming an electrode from the metal substrate.

23. The method of claim 22 wherein the electrode is a positive electrode.

24. The method of claim 23 wherein the electrode is a negative electrode.

25. A method, comprising:
sintering a powdered metal on a metal substrate, and
forming a layer of nickel hydroxide on the metal substrate.

26. The method of claim 25 wherein the metal substrate is used as an electrode in an energy storage device.

27. A method, comprising:
sintering a powdered metal onto a metal substrate at about the glass transition temperature of the powdered metal, and
forming an electrode from the metal substrate.

28. The method of claim 27 wherein the sintered powdered metal comprises nickel.

29. The method of claim 27 wherein the metal substrate comprises nickel plated steel.

30. The method of claim 27 comprising extruding a layer of nickel metal hydride onto the sintered powdered metal substrate.

31. A method of making an electrode, comprising:
providing a substrate comprising a first material,
forming a first layer by sintering a second material on the substrate, and
forming a second layer comprising a third material.

32. The method of claim 31 wherein the first material comprises at least one of a metal and a metal alloy.

33. The method of claim 31 wherein the second material comprises a powdered metal.

34. The method of claim 31 wherein the third material comprises an electrolyticly active material

35. The method of claim 31 wherein the third material comprises an electrolyticly non-active material.

36. The method of claim 31 wherein at least one of the first layer and the second layer are absent from at least a portion of the substrate.

37. An electrode, comprising:
a substrate comprising a first material,
a first layer formed by sintering a second material on the substrate, and
a second layer comprising a third material.

38. The electrode of claim 37 wherein the first material comprises at least one of a metal and a metal alloy.

39. The electrode of claim 37 wherein the second material comprises a powdered metal.

40. The electrode of claim 37 wherein the third material comprises an electrolyticly active material

41. The electrode of claim 37 wherein the third material comprises an electrolyticly non-active material.

42. The electrode of claim 37 wherein at least one of the first layer and the second layer are absent from at least a portion of the substrate.

43. An energy storage device comprising:
an electrode, the electrode comprising:
a substrate comprising a first material,
a first layer formed by sintering a second material on the substrate, and
a second layer comprising a third material.

44. An apparatus comprising:
an energy storage device, and
a configuration enabling use of energy stored in the energy storage device,
the energy storage device comprising an electrode, the electrode comprising:
a substrate comprising a first material,
a first layer formed by sintering a second material on the substrate, and
a second layer comprising a third material.

45. A method comprising:
providing an energy storage device comprising an electrode, the electrode comprising:
a substrate comprising a first material,
a first layer formed by sintering a second material on the substrate, and
a second layer comprising a third material, and
accessing energy stored in the energy storage device.
